(19) United States
(12) Patent Application Publication
(10) Pub. No.: US 2022/0367915 A1
(43) Pub. Date: Nov. 17, 2022

(54) NON-AQUEOUS ELECTROLYTE SOLUTION, AND SECONDARY BATTERY COMPRISING NON-AQUEOUS ELECTROLYTE SOLUTION

(71) Applicant: Prime Planet Energy & Solutions, Inc., Tokyo (JP)

(72) Inventors: Simpei KONDO, Nagoya-shi (JP); Hiroto ASANO, Nisshin-shi (JP)

(21) Appl. No.: 17/745,783

(22) Filed: May 16, 2022

(30) Foreign Application Priority Data
May 17, 2021 (JP) 2021-083090

(51) Int. Cl. H01M 10/0569

(52) U.S. Cl. CPC H01M 10/0569; H01M 2300/0051; H01M 2300/0028

(57) ABSTRACT

Provided is a non-aqueous electrolyte solution that achieves a favorable balance between suppressing an increase in resistance and improving metallic Li precipitation resistance in an embodiment that contains LiPO₂F₂. The non-aqueous electrolyte solution disclosed here is used in a non-aqueous electrolyte secondary battery, and contains lithium difluorophosphate and a Cs cation-containing compound. When the total amount of the non-aqueous electrolyte solution is taken to be 100 mass %, the content of the lithium difluorophosphate is 1.0 mass % or less and the content of the Cs cation-containing compound is 0.1 to 0.5 mass %.

### CROSS REFERENCE TO RELATED APPLICATIONS

The present application claims priority on the basis of Japanese Patent Application No. 2021-083090, which was filed on 17 May 2021, and the entire contents of that application are incorporated by reference in the present specification.

### BACKGROUND

The present disclosure relates to a non-aqueous electrolyte solution, and to a secondary battery comprising the non-aqueous electrolyte solution.

In recent years, non-aqueous electrolyte secondary batteries such as lithium ion secondary batteries have been advantageously used as portable power sources for personal computers, handheld devices, and the like, and as motive power sources for vehicles such as electric vehicles (BEV), hybrid vehicles (HEV) and plug-in hybrid vehicles (PHEV).

Addition of lithium difluorophosphate (LiPO₂F₂) to non-aqueous electrolyte solutions of non-aqueous electrolyte secondary batteries is a known feature (see Japanese Patent Application Publication No. 2005-219994 and WO 2017/047019). By adding LiPO₂F₂, a SEI (Solid Electrolyte Interphase) coating film is formed on the surface of a negative electrode, and it is known that this can realize a reduction in battery resistance and suppress precipitation of metallic lithium (hereinafter also referred to as “metallic Li”) caused by a reduction in negative electrode potential at the time of charging.

### SUMMARY

However, as a result of diligent research, the inventors of the present disclosure understood that there is room for improvement in terms of suppression of precipitation of metallic Li in cases where LiPO₂F₂ is added to a non-aqueous electrolyte solution.

With these circumstances in mind, the main purpose of the present disclosure is to provide is a non-aqueous electrolyte solution that achieves a favorable balance between suppressing an increase in resistance and improving metallic Li precipitation resistance in an embodiment that contains LiPO₂F₂.

In order to achieve this objective, the present disclosure provides a non-aqueous electrolyte solution able to be used in a non-aqueous electrolyte secondary battery. This non- aqueous electrolyte solution contains lithium difluorophosphate and a Cs cation-containing compound, and when the total amount of the non-aqueous electrolyte solution is taken to be 100 mass %, the content of the lithium difluorophosphate is 1.0 mass % or less and the content of the Cs cation-containing compound is 0.1 to 0.5 mass %.

The inventors of the present disclosure found that by reducing the added quantity (to 1.0 mass % or less in this case) of lithium difluorophosphate, which can be a cause of precipitation of metallic Li, and adding a small quantity (0.1 to 0.5 mass % in this case) of a Cs cation-containing compound, it is possible to achieve a favorable balance between suppressing an increase in battery resistance and improving metallic Li precipitation resistance, and thereby completed the present disclosure.

In a preferred aspect of the non-aqueous electrolyte solution disclosed here, the Cs cation-containing compound includes at least one compound selected from the group consisting of CsPO₂F₂, CsPF₆ and CsFSI. According to a non-aqueous electrolyte solution having such a configuration, it is possible to achieve a more favorable balance between suppressing an increase in resistance and improving metallic Li precipitation resistance.

In a preferred aspect of the non-aqueous electrolyte solution disclosed here, at least one type of solvent belonging to the carbonate group is contained as a non-aqueous solvent. By incorporating a solvent belonging to the carbonate group (it is more preferable for the non- aqueous solvent to be constituted from a solvent belonging to the carbonate group), it is possible to provide a non-aqueous electrolyte solution able to be used more advantageously in a non-aqueous electrolyte secondary battery.

In addition, another aspect of the present disclosure provides a non-aqueous electrolyte secondary battery comprising the non-aqueous electrolyte solution disclosed here. According to such a non-aqueous electrolyte secondary battery, it is possible to achieve a favorable balance between suppressing an increase in resistance and improving metallic Li precipitation resistance.

### BRIEF DESCRIPTION OF THE DRAWINGS

FIG. 1 is a cross-sectional view that schematically illustrates the configuration of a lithium ion secondary battery according to one embodiment of the present disclosure; and

FIG. 2 is an exploded view that illustrates a configuration of a wound electrode body provided in a lithium ion secondary battery according to one embodiment of the present disclosure.

### DETAILED DESCRIPTION

Preferred one embodiment relating to the non-aqueous electrolyte solution disclosed here and a secondary battery obtained using said non-aqueous electrolyte solution will now be explained in detail, with reference to the drawings as appropriate. Matters other than those explicitly mentioned in the present specification but which are essential for carrying out the disclosure are matters that a person skilled in the art could understand to be matters of design on the basis of the prior art in this technical field. The present disclosures can be carried out on the basis of the matters disclosed in the present specification and common general technical knowledge in this technical field. Moreover, the embodiment explained below is not intended to limit the features disclosed here. In addition, members/parts that perform the same action are denoted by the same symbols in the drawings shown in the present specification. Furthermore, dimensional relationships (length, width, thickness and so on) in the drawings do not reflect actual dimensional relationships.

Moreover, in the specification and claims of the present disclosure, cases where numerical ranges are written as A to B (here, A and B are arbitrary numbers) mean not less than A and not more than B. Therefore, this also encompasses a range that is greater than A and a range that is less than B.

Moreover, the term “secondary battery” in the present specification means electricity storage devices that can be repeatedly charged and discharged, and is a term that encompasses so-called storage batteries and electricity storage devices such as electrical double layer capacitors. In addition, the term “lithium ion secondary battery” in the present specification means a secondary battery in which lithium ions are used as charge carriers and charging and discharging are effected by means of charge transfer involving lithium ions between positive and negative electrodes.

The non-aqueous electrolyte solution according to the present embodiment contains lithium difluorophosphate (LiPO₂F₂) and a Cs cation-containing compound. In addition, this non-aqueous electrolyte solution is characterized in that if the total amount of the non-aqueous electrolyte solution is taken to be 100 mass %, the content of the LiPO₂F₂ is 1.0 mass % or less and the content of the Cs cation-containing compound is 0.1 to 0.5 mass %.

As a result of diligent research, the inventors of the present disclosure found that by reducing the added quantity (to 1.0 mass % or less in this case) of LiPO₂F₂, which can be a cause of precipitation of metallic Li if added in excess, to a quantity at which a SEI coating film is formed and adding a small quantity (0.1 to 0.5 mass % in this case) of a Cs cation-containing compound, it is possible to achieve a favorable balance between suppressing an increase in battery resistance and improving metallic Li precipitation resistance. Without being intended to be interpreted in any particular way, the mechanism by which metallic Li precipitation resistance is improved through addition of a small quantity of a Cs cation-containing compound is thought to be as follows.

For example, in a case where a metallic Li nucleus is produced, it is thought that a cation of cesium (Cs), which has a lower precipitation potential than Li, is drawn to the periphery of the nucleus, thereby exhibiting an electrostatic shielding effect. In addition, because the precipitation potential of Cs decreases as the concentration of Cs cations decreases, in a case where a small quantity of a Cs cation-containing compound is added, it is thought that the difference between the precipitation potential of Cs and the precipitation potential of Li becomes greater (that is, Cs becomes less likely to precipitate at a potential close to the Li precipitation potential). As a result, it is understood that precipitation of metallic Li can be favorably suppressed (in other words, metallic Li precipitation resistance can be favorably improved). Therefore, according to a non-aqueous electrolyte solution in which the added quantity of LiPO₂F₂ is reduced to a quantity whereby a SEI coating film is formed and to which is added a small quantity of a Cs cation-containing compound, it is thought that it is possible to achieve a favorable balance between suppressing an increase in battery resistance and improving metallic Li precipitation resistance.

If the total amount of the non-aqueous electrolyte solution disclosed here is taken to be 100 mass %, the content of LiPO₂F₂ contained in the non-aqueous electrolyte solution is 1.0 mass % or less, as mentioned above. In addition, the lower limit for the added quantity of LiPO₂F₂ is not particularly limited as long as the advantageous effects of the features disclosed here can be achieved, but this lower limit can generally be approximately 0.1 mass % or more, preferably 0.2 mass % or more, and more preferably 0.3 mass % or more. For example, a commercially available product can be used as the LiPO₂F₂.

The Cs cation-containing compound can be called a salt of a Cs cation (Cs⁺) and an anion represented by X⁻. Examples of the anion represented by X⁻include PO₂F₂⁻(a difluorophosphate ion), PF₆₋ (a hexafluorophosphate ion), FSI⁻ (a bis(fluorosulfonyl)imide ion), BF₄₋ (a tetrafluoroborate ion), B(C₂O₄)₂₋ (a bisoxalatoborate ion), TFSI⁻ (a bis(trifluoromethanesulfonyl)imide ion) and a variety of other anions. It is possible to use one Cs cation-containing compound in isolation or an appropriate combination of two or more types thereof. Moreover, in a case where the Cs cation-containing compound includes at least one type selected from the group consisting of CsPO₂F₂, CsPF₆ and CsFSI, it is possible to achieve a more favorable balance between suppressing an increase in resistance and improving metallic Li precipitation resistance. In addition, if the total amount of the non-aqueous electrolyte solution disclosed here is taken to be 100 mass %, the content of the Cs cation-containing compound contained in the non-aqueous electrolyte solution is 0.1 to 0.5 mass %, and more preferably 0.2 to 0.5 mass %. For example, a commercially available product can be used as the Cs cation-containing compound.

Typically, non-aqueous electrolyte solutions also contain a non-aqueous solvent and a supporting electrolyte (an electrolyte salt). Organic solvents able to be used in electrolyte solutions of ordinary lithium ion secondary batteries, such as a variety of carbonates, ethers, esters, nitriles, sulfones and lactones, can be used without particular limitation as the non-aqueous solvent. It is possible to use one such non-aqueous solvent in isolation or an appropriate combination of two or more types thereof. Of these, it is preferable to contain a solvent belonging to the carbonate group (it is more preferable for the non-aqueous solvent to be constituted from a solvent belonging to the carbonate group). Specific examples of solvents belonging to the carbonate group include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC) and trifluorodimethyl carbonate (TFDMC).

A variety of supporting electrolytes able to be used in ordinary lithium ion secondary batteries can be used without particular limitation as the supporting electrolyte. Lithium salts such as LiPF₆, LiBF₄, lithium bis(fluorosulfonyl)imide (LiFSI) and lithium bis(trifluoromethane)sulfonimide (LiTFSI) (and preferably LiPF₆) can be advantageously used as the supporting electrolyte. It is possible to use one of these supporting electrolytes in isolation or a combination of two or more types thereof

The concentration of the supporting electrolyte is not particularly limited as long as the advantageous effects of the features disclosed here are achieved. From the perspective of adequately exhibiting the function of a supporting electrolyte, the concentration of the supporting electrolyte in the non-aqueous electrolyte solution is preferably 0.5 to 3 mol/L, and more preferably 0.8 to 1.6 mol/L.

Moreover, the non-aqueous electrolyte solution according to the present embodiment may contain a variety of additives, for example gas generating agents such as biphenyl (BP) and cyclohexylbenzene (CHB); film-forming agents; dispersing agents; and thickening agents, as long as the advantageous effect of the present disclosure is not significantly impaired.

The non-aqueous electrolyte solution according to the present embodiment can be produced using a conventional well-known method. In addition, the non-aqueous electrolyte solution according to the present embodiment can be used in a lithium ion secondary battery in accordance with a conventional well-known method. By using the non-aqueous electrolyte solution according to the present embodiment in a non-aqueous electrolyte secondary battery (a lithium ion secondary battery in this case), it is possible to achieve a favorable balance between suppressing an increase in battery resistance and improving metallic Li precipitation resistance.

A non-aqueous electrolyte secondary battery comprising the non-aqueous electrolyte solution according to the present embodiment will now be explained in detail by using, as an example, a flat square lithium ion secondary battery having a flat wound electrode body and a flat battery case. However, the non-aqueous electrolyte secondary battery according to the present embodiment is not limited to the example described below.

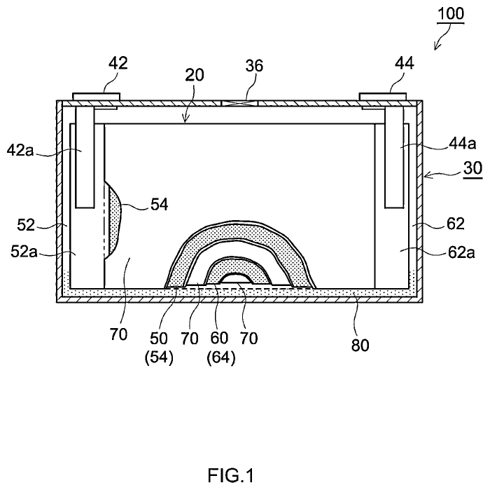

A lithium ion secondary battery 100 shown in FIG. 1 is a sealed battery constructed by housing a flat wound electrode body 20 and a non-aqueous electrolyte solution 80 in a flat square battery case (that is, an outer container) 30. The battery case 30 is provided with a positive electrode terminal 42 and negative electrode terminal 44 for external connections, and a thin-walled safety valve 36, which is set to release the pressure inside the battery case 30 when this pressure exceeds a prescribed level. The positive electrode terminal 42 and the negative electrode terminal 44 are electrically connected to a positive electrode current collector plate 42a and a negative electrode current collector plate 44a respectively. A metallic material which is lightweight and exhibits good thermal conductivity, such as aluminum, can be used as the constituent material of the battery case 30.

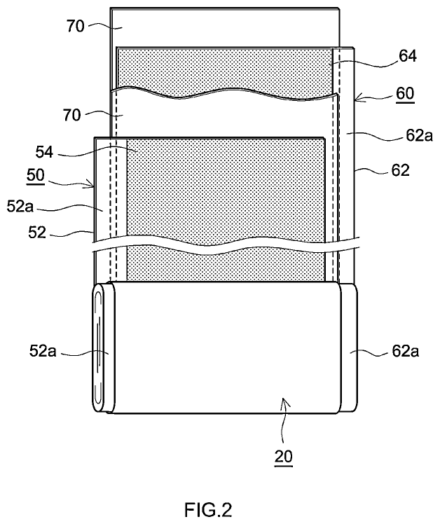

As shown in FIG. 1 and FIG. 2, the wound electrode body 20 is formed into a flat shape by overlaying a positive electrode sheet 50 and a negative electrode sheet 60, with two long strip-shaped separator sheets 70 interposed therebetween, and then winding this overlaid article in the longitudinal direction. The positive electrode sheet 50 is configured such that a positive electrode active substance layer 54 is formed in the longitudinal direction on one surface or both surfaces of a long positive electrode current collector 52. The negative electrode sheet 60 is configured such that a negative electrode active substance layer 64 is formed in the longitudinal direction on one surface or both surfaces of a long negative electrode current collector 62. A positive electrode active substance layer-non-formed part 52a (that is, a part on which the positive electrode active substance layer 54 is not formed and the positive electrode current collector 52 is exposed) and a negative electrode active substance layer-non-formed part 62a (that is, a part on which the negative electrode active substance layer 64 is not formed and the negative electrode current collector 62 is exposed) are formed so as to protrude outwards from the edges of the wound electrode body 20 in the winding axis direction (that is, the sheet width direction that is perpendicular to the longitudinal direction). The positive electrode current collector plate 42a is connected to the positive electrode active substance layer-non-formed part 52a, and the negative electrode current collector plate 44a is connected to the negative electrode active substance layer-non-formed part 62a.

A well-known positive electrode current collector able to be used in lithium ion secondary batteries may be used as the positive electrode current collector 52, and examples thereof include sheets and foils of metals that exhibit good electrical conductivity (for example, aluminum, nickel, titanium, stainless steel, and the like). An aluminum foil is preferred as the positive electrode current collector 52.

The size of the positive electrode current collector 52 is not particularly limited, and should be decided as appropriate according to battery design. In a case where an aluminum foil is used as the positive electrode current collector 52, the thickness thereof is not particularly limited, but is, for example, 5 μm to 35 μm, and preferably 7 μm to 20 μm.

For example, a lithium-transition metal oxide (for example, LiNi_{⅓}Co_{⅓}Mn_{⅓}O₂, LiNiO₂, LiCoO₂, LiFeO₂, LiMn₂O₄, LiNi_{0.5}Mn_{1.5}O₄ or the like) or a lithium-transition metal phosphate compound (for example, LiFePO₄), or the like, can be used as the positive electrode active substance contained in the positive electrode active substance layer 54.

The average particle diameter (median diameter: D50) of the positive electrode active substance is not particularly limited, but is, for example, 0.1 μm to 25 μm, preferably 1 μm to 20 μm, and more preferably 5 μm to 15 μm. Moreover, the term “average particle diameter” in the present description means a particle diameter corresponding to a cumulative value of 50% from the small particle diameter side in a volume-based particle size distribution determined by, for example, a laser diffraction/scattering method.

The positive electrode active substance layer 54 may contain components other than the positive electrode active substance, for example trilithium phosphate, electrically conductive materials, binders, and the like. Carbon black such as acetylene black (AB) and other carbon materials (for example, graphite or the like) can be advantageously used as an electrically conductive material. For example, poly(vinylidene fluoride) (PVDF) or the like can be used as a binder.

The content of the positive electrode active substance in the positive electrode active substance layer 54 (that is, the content of the positive electrode active substance relative to the total mass of the positive electrode active substance layer 54) is not particularly limited, but is preferably 70 mass % or more, more preferably 80 to 97 mass %, and further preferably 85 to 96 mass %. The content of trilithium phosphate in the positive electrode active substance layer 54 is not particularly limited, but is preferably 1 to 15 mass %, and more preferably 2 to 12 mass %. The content of an electrically conductive material in the positive electrode active substance layer 54 is not particularly limited, but is preferably 1 to 15 mass %, and more preferably 3 to 13 mass %. The content of a binder in the positive electrode active substance layer 54 is not particularly limited, but is preferably 1 to 15 mass %, and more preferably 1.5 to 10 mass %.

The thickness of the positive electrode active substance layer 54 is not particularly limited, but is, for example, 10 μm to 300 μm, and preferably 20 μm to 200 μm.

A well-known negative electrode current collector able to be used in lithium ion secondary batteries may be used as the negative electrode current collector 62, and examples thereof include sheets and foils of metals that exhibit good electrical conductivity (for example, copper, nickel, titanium, stainless steel, and the like). A copper foil is preferred as the negative electrode current collector 62.

The size of the negative electrode current collector 62 is not particularly limited, and should be decided as appropriate according to battery design. In a case where a copper foil is used as the negative electrode current collector 62, the thickness thereof is not particularly limited, but is, for example, 5 μm to 35 μm, and preferably 7 μm to 20 μm.

The negative electrode active substance layer 64 contains a negative electrode active substance. For example, a carbon material such as graphite, hard carbon or soft carbon can be used as the negative electrode active substance. The graphite can be natural graphite or artificial graphite, and may be amorphous carbon-coated graphite in a form whereby graphite is coated with an amorphous carbon material.

The average particle diameter (median diameter: D50) of the negative electrode active substance is not particularly limited, but is, for example, 0.1 μm to 50 μm, preferably 1 μm to 25 μm, and more preferably 5 μm to 20 μm.

The negative electrode active substance layer 64 can contain components other than the active substance, such as a binder or a thickening agent. For example, a styrene-butadiene butadiene rubber (SBR), poly(vinylidene fluoride) (PVDF), or the like, can be used as a binder. For example, carboxymethyl cellulose (CMC) or the like can be used as a thickening agent.

The content of the negative electrode active substance in the negative electrode active substance layer is preferably 90 mass % or more, and more preferably 95 to 99 mass %. The content of a binder in the negative electrode active substance layer is preferably 0.1 to 8 mass %, and more preferably 0.5 to 3 mass %. The content of a thickening agent in the negative electrode active substance layer is preferably 0.3 to 3 mass %, and more preferably 0.5 to 2 mass %.

The thickness of the negative electrode active substance layer 64 is not particularly limited, but is, for example, 10 μm to 300 μm, and preferably 20 μm to 200 μm.

Examples of the separator 70 include porous sheets (films) comprising resins such as polyethylene (PE), polypropylene (PP), polyesters, cellulose and polyamides. This type of porous sheet may have a single layer structure or a laminated structure having two or more layers (for example, a three layer structure obtained by laminating a PP layer on both surfaces of a PE layer). A heat-resistant layer (HRL) may be provided on a surface of the separator 70.

The non-aqueous electrolyte solution according to the present embodiment mentioned above can be used in the non-aqueous electrolyte solution 80. Moreover, FIG. 1 does not accurately show the amount of non-aqueous electrolyte solution 80 injected into the battery case 30.

The lithium ion secondary battery 100 constituted in the manner described above can be used in a variety of applications. Examples of preferred applications include motive power sources fitted to vehicles such as electric vehicles (BEV), hybrid vehicles (HEV) and plug in hybrid vehicles (PHEV). The lithium ion secondary battery 100 can typically also be used in the form of a battery pack in which a plurality of batteries are connected in series and/or in parallel.

As one example, an explanation will be given of a square lithium ion secondary battery 100 provided with a flat wound electrode body 20. However, the non-aqueous electrolyte secondary battery disclosed here can also be constituted as a lithium ion secondary battery having a laminated electrode body (that is, an electrode body in which a plurality of positive electrodes and a plurality of negative electrodes are alternately layered). In addition, the non-aqueous electrolyte secondary battery disclosed here can be configured as a coin- shaped lithium ion secondary battery, a button-shaped lithium ion secondary battery, a cylindrical lithium ion secondary battery, a laminated lithium ion secondary battery, or the like. In addition, the non-aqueous electrolyte secondary battery disclosed here can be configured as a non-aqueous electrolyte secondary battery other than a lithium ion secondary battery in accordance with publicly known methods.

Explanations will now be given of working examples relating to the present disclosure, but it is not intended that the present disclosure is limited to these working examples.

### Preparation of Non-Aqueous Electrolyte Solution

A mixed solvent containing ethylene carbonate (EC), dimethyl carbonate (DMC) and ethyl methyl carbonate (EMC) at a volume ratio of 30:40:30 was prepared as a non-aqueous solvent. In addition, LiPF₆ was added as a supporting electrolyte at a concentration of 1.0 M. Non-aqueous electrolyte solutions according to various samples were produced by adding an additive shown in Table 1 (LiPO₂F₂) and a Cs cation-containing compound to this mixed solvent at content values shown in Table 1 relative to a total of 100 mass % of the overall non-aqueous electrolyte solution.

### Production of Evaluation Lithium Ion Secondary Batteries

A positive electrode active substance layer-forming slurry was prepared by mixing LiNi_{⅓}Co_{⅓}Mn_{⅓}O₂ (LNCM) as a positive electrode active substance powder, acetylene black (AB) as an electrically conductive material and poly(vinylidene fluoride) (PVdF) as a binder with N-methylpyrrolidone (NMP) at quantities whereby the LNCM:AB:PVdF mass ratio was 87:10:3. A positive electrode sheet was produced by coating this slurry on an aluminum foil, drying, and then rolling and pressing.

A negative electrode active substance layer-forming slurry was prepared by mixing a natural graphite-based material (C) (having an average particle diameter of 20 μm) as a negative electrode active substance, a styrene butadiene rubber (SBR) as a binder and carboxymethyl cellulose (CMC) as a thickening agent with ion exchanged water at quantities whereby the C: SBR: CMC mass ratio was 98:1:1. A negative electrode sheet was produced by coating this slurry on a copper foil, drying, and then rolling and pressing.

In addition, a porous polyolefin sheet having a three layer structure comprising PP/PE/PP (this sheet had an air permeability, as measured using the Gurley test method, of 250 seconds) was prepared as a separator sheet.

As mentioned above, an electrode body was produced by disposing the thus produced positive electrode sheet and negative electrode sheet so as to face each other, with the separator sheet interposed therebetween. Next, the current collector was attached to the electrode body and housed in a laminated case together with a non-aqueous electrolyte solution of a sample. An evaluation lithium ion secondary battery was obtained by sealing the laminated case.

### Conditioning

Each lithium ion secondary battery prepared in the manner described above was placed in an environment at a temperature of 25° C. Each lithium ion secondary battery was charged at a constant current of 0.3 C to a voltage of 4.1 V, and then discharged at a constant current of 0.3 C to a voltage of 3.0 V. Next, the battery was charged at a constant current of 0.2 C to a voltage of 4.1 V and then charged at a constant voltage until a current of 1/50C was reached, and a fully charged state was attained. In addition, the initial capacity was taken to be the capacity when the battery was discharged at a constant current of 0.2 C to a voltage of 3.0 V.

### Measurement of Initial Battery Resistance

The initial capacity of a conditioned lithium ion secondary battery was taken to be a SOC of 100%, and the battery was charged at a current of 0.3 C in an environment at 25° C. until a SOC of 30% was reached. This battery was left in an environment at a temperature of −30° C. and then discharged for 2 seconds. The discharging current rate was 3 C, 5 C, 8 C and 12 C, and the voltage was measured after discharging at these current rates. IV resistance was calculated from the current rate and the voltage change rate, and the average value thereof was taken to be the initial battery resistance. Initial resistance values for other batteries were calculated as ratios, with the resistance of the lithium ion secondary battery according to Sample 15 being recorded as “1.00”. Results are shown in the “Initial resistance ratio” column in Table 1. Moreover, a case where the initial resistance ratio is 1.1 or less can be evaluated as being able to favorably suppress an increase in battery resistance.

### Measurement of Metallic Lithium Precipitation Resistance and Capacity Retention Rate

An evaluation lithium ion secondary battery that had been subjected to the initial battery resistance measurements described above was charged at a current of 0.3 C in an environment at 25° C. until a SOC of 60% was reached. This battery was left in an environment at a temperature of −30° C. and subjected to 10,000 cycles comprising charging and discharging with a pulsed current having a duration of 0.5 seconds and a current of 20 C. Capacity was then measured in the same way as initial capacity. Capacity retention rate was determined as: capacity retention rate (%)=(capacity after charging and discharging cycles/initial capacity)×100. Capacity retention rate results are shown in the “Capacity retention rate following low temperature pulse test” column in Table 1. Moreover, a higher capacity retention rate means a better metallic Li precipitation resistance evaluation. Here, a case where the capacity retention rate is 98% or more is evaluated as an excellent capacity retention rate (that is, excellent metallic Li precipitation resistance).

TABLE 1

| | | | | | | Capacity |
|---|---|---|---|---|---|---|
| | | | | | | retention rate |
| | Additive | | Cs cation-containing compound | | | following low |
| | | Added | | Added | Initial | temperature |
| | | quantity | | quantity | resistance | pulse test |
| | Type | (%) | Type | (%) | ratio | (%) |
| Sample 1 | LiPO₂F₂ | 1.0 | CsPO₂F₂ | 0.2 | 0.99 | 99.6 |
| Sample 2 | | 1.0 | | 0.5 | 1.01 | 99.3 |
| Sample 3 | | 1.0 | | 0.1 | 1.02 | 98.7 |
| Sample 4 | | 0.5 | | 0.2 | 1.02 | 99.1 |
| Sample 5 | | 0.5 | | 0.1 | 1.02 | 98.6 |
| Sample 6 | | 0.3 | | 0.1 | 1.05 | 98.4 |
| Sample 7 | | 1.0 | CsPF₆ | 0.2 | 1.05 | 98.6 |
| Sample 8 | | 0.5 | | 0.2 | 1.03 | 98.3 |
| Sample 9 | | 0.5 | | 0.1 | 1.05 | 98.4 |
| Sample 10 | | 0.3 | | 0.1 | 1.03 | 98.0 |
| Sample 11 | | 1.0 | CsFSI | 0.2 | 1.00 | 98.8 |
| Sample 12 | | 0.5 | | 0.2 | 1.01 | 98.9 |
| Sample 13 | | 0.5 | | 0.1 | 1.03 | 98.3 |
| Sample 14 | | 0.3 | | 0.1 | 1.03 | 98.4 |
| Sample 15 | | 1.0 | — | — | 1.00 | 97.6 |
| Sample 16 | — | — | CsPO₂F₂ | 1.0 | 1.03 | 94.3 |
| Sample 17 | — | — | | 0.2 | 1.09 | 73.9 |
| Sample 18 | LiPO₂F₂ | — | CsPF₆ | 1.0 | —*¹ | —*¹ |
| Sample 19 | | — | | 0.2 | 1.17 | 68.4 |
| Sample 20 | | — | CsFSI | 1.0 | 1.09 | 81.9 |
| Sample 21 | | — | | 0.2 | 1.13 | 70.1 |
| Sample 22 | | 1.0 | CsPO₂F₂ | 1.0 | 1.02 | 91.3 |
| Sample 23 | | 1.5 | | 0.2 | 1.07 | 94.9 |

*¹Because CsPF₆ did not completely dissolve, evaluations were not carried out.

As shown in Table 1, it was confirmed that lithium ion secondary batteries according to Samples 1 to 14, which were comprising a non-aqueous electrolyte solution which contained LiPO₂F₂ as an additive and a Cs cation-containing compound and in which the content of the LiPO₂F₂ was 1.0 mass % or less and the content of the Cs cation-containing compound was 0.1 to 0.5 mass %, each relative to a total of 100 mass % of the overall non-aqueous electrolyte solution, more favorably achieved an improvement in metallic Li precipitation resistance while suppressing an increase in battery resistance (initial battery resistance in this case) in comparison with Sample 15, in which LiPO₂F₂ was used in isolation, Samples 16 to 21, in which a Cs cation-containing compound was used in isolation, Sample 22, in which the content of LiPO₂F₂ was 1.0 mass % or less but the content of a Cs cation-containing compound fell outside the range mentioned above, and Sample 23, in which the content of LiPO₂F₂ was greater than 1.0 mass % but the content of a Cs cation-containing compound fell within the range mentioned above.

Specific examples of the present disclosure have been explained in detail above, but these are merely examples, and do not limit the scope of the claims. The features set forth in the claims also encompass modes obtained by variously modifying or altering the specific examples shown above.

1. A non-aqueous electrolyte solution which is used in a non-aqueous electrolyte secondary battery comprising:
lithium difluorophosphate and a Cs cation-containing compound, wherein:
when the total amount of the non-aqueous electrolyte solution is taken to be 100 mass %, the content of the lithium difluorophosphate is 1.0 mass % or less and the content of the Cs cation-containing compound is 0.1 to 0.5 mass %.

2. The non-aqueous electrolyte solution according to claim 1, wherein:
the Cs cation-containing compound includes at least one compound selected from the group consisting of CsPO₂F₂, CsPF₆ and CsFSI.

3. The non-aqueous electrolyte solution according to claim 1, which contains at least one type of solvent belonging to the carbonate group as a non-aqueous solvent.

4. A non-aqueous electrolyte secondary battery comprising the non-aqueous electrolyte solution according to claim 1 as a non-aqueous electrolyte solution.
